(19) United States
(12) Patent Application Publication
(10) Pub. No.: US 2023/0254864 A1
(43) Pub. Date: Aug. 10, 2023

(54) UPLINK CONTROL INFORMATION MULTIPLEXING

(71) Applicant: QUALCOMM Incorporated, San Diego, CA (US)

(72) Inventors: Fang YUAN, Beijing (CN); Wooseok NAM, San Diego, CA (US); Tao LUO, San Diego, CA (US)

(21) Appl. No.: 18/003,208

(22) PCT Filed: Aug. 13, 2020
(86) PCT No.: PCT/CN2020/108791

§ 371 Date: Dec. 23, 2022

(51) Int. Cl. H04W 72/21; H04L 5/00; H04W 72/1268

(52) U.S. Cl. CPC H04W 72/21; H04L 5/0053; H04W 72/1268

(57) ABSTRACT

Various aspects of the present disclosure generally relate to wireless communication. In some aspects, a user equipment (UE) may determine that a physical uplink shared channel (PUSCH) resource for reporting one or more first channel state information (CSI) reports overlaps with a physical uplink control channel (PUCCH) resource for reporting one or more second CSI reports. The UE may transmit the one or more first CSI reports multiplexed with at least a portion of the one or more second CSI reports in uplink control information in the PUSCH resource. Numerous other aspects are provided.

### FIELD OF THE DISCLOSURE

Aspects of the present disclosure generally relate to wireless communication and to techniques and apparatuses for uplink control information multiplexing.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes: determining that a physical uplink shared channel (PUSCH) resource for reporting one or more first channel state information (CSI) reports overlaps with a physical uplink control channel (PUCCH) resource for reporting one or more second CSI reports; and transmitting the one or more first CSI reports multiplexed with at least a portion of the one or more second CSI reports in uplink control information in the PUSCH resource.

In some aspects, a method of wireless communication performed by a base station includes: determining that a PUSCH resource for a UE to report one or more first CSI reports overlaps with a PUCCH resource for the UE to report one or more second CSI reports; and receiving the one or more first CSI reports multiplexed with at least a portion of the one or more second CSI reports in uplink control information in the PUSCH resource.

In some aspects, a UE for wireless communication includes a memory and one or more processors operatively coupled to the memory, the memory and the one or more processors configured to: determine that a PUSCH resource for reporting one or more first CSI reports overlaps with a PUCCH resource for reporting one or more second CSI reports; and transmit the one or more first CSI reports multiplexed with at least a portion of the one or more second CSI reports in uplink control information in the PUSCH resource.

In some aspects, a base station for wireless communication includes a memory and one or more processors operatively coupled to the memory, the memory and the one or more processors configured to: determine that a PUSCH resource for a UE to report one or more first CSI reports overlaps with a PUCCH resource for the UE to report one or more second CSI reports; and receive the one or more first CSI reports multiplexed with at least a portion of the one or more second CSI reports in uplink control information in the PUSCH resource.

In some aspects, a non-transitory computer-readable medium storing a set of instructions for wireless communication includes one or more instructions that, when executed by one or more processors of a UE, cause the UE to: determine that a PUSCH resource for reporting one or more first CSI reports overlaps with a PUCCH resource for reporting one or more second CSI reports; and transmit the one or more first CSI reports multiplexed with at least a portion of the one or more second CSI reports in uplink control information in the PUSCH resource.

In some aspects, a non-transitory computer-readable medium storing a set of instructions for wireless communication includes one or more instructions that, when executed by one or more processors of a base station, cause the base station to: determine that a PUSCH resource for a UE to report one or more first CSI reports overlaps with a PUCCH resource for the UE to report one or more second CSI reports; and receive the one or more first CSI reports multiplexed with at least a portion of the one or more second CSI reports in uplink control information in the PUSCH resource.

In some aspects, an apparatus for wireless communication includes: means for determining that a PUSCH resource for reporting one or more first CSI reports overlaps with a PUCCH resource for reporting one or more second CSI reports; and means for transmitting the one or more first CSI reports multiplexed with at least a portion of the one or more second CSI reports in uplink control information in the PUSCH resource.

In some aspects, an apparatus for wireless communication includes: means for determining that a PUSCH resource for a UE to report one or more first CSI reports overlaps with a PUCCH resource for the UE to report one or more second CSI reports; and means for receiving the one or more first CSI reports multiplexed with at least a portion of the one or more second CSI reports in uplink control information in the PUSCH resource.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating an example associated with uplink control information multiplexing, in accordance with various aspects of the present disclosure.

FIGS. 4 and 5 are diagrams illustrating example processes associated with uplink control information multiplexing, in accordance with various aspects of the present disclosure.

FIGS. 6 and 7 are diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

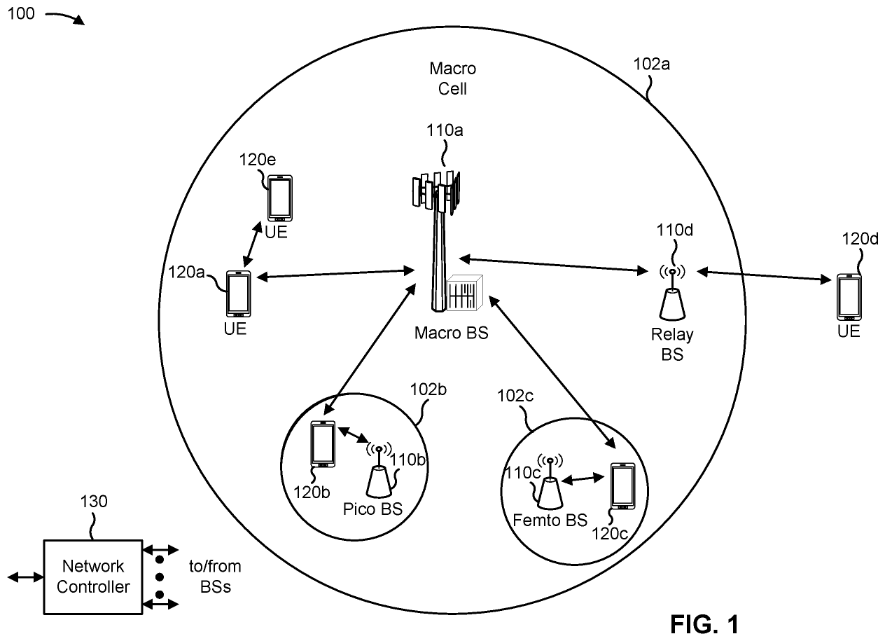

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband interne of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

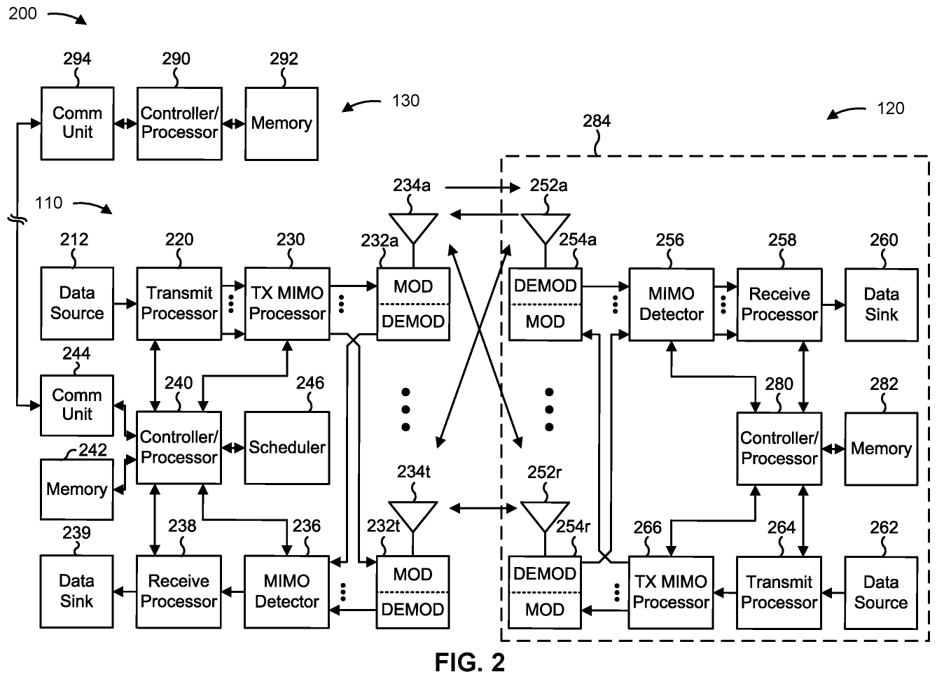

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

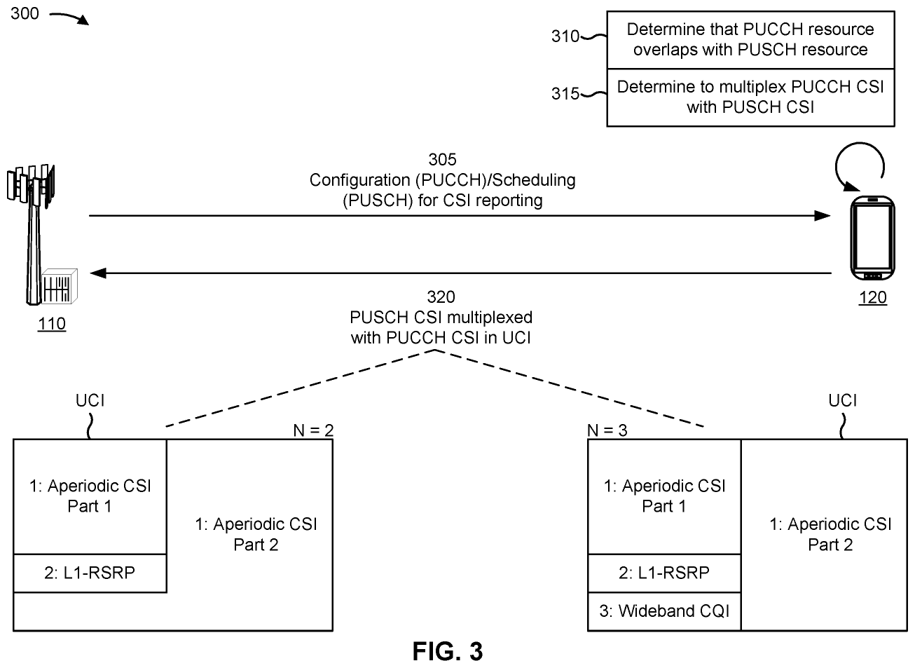

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 3-5.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 3-5.

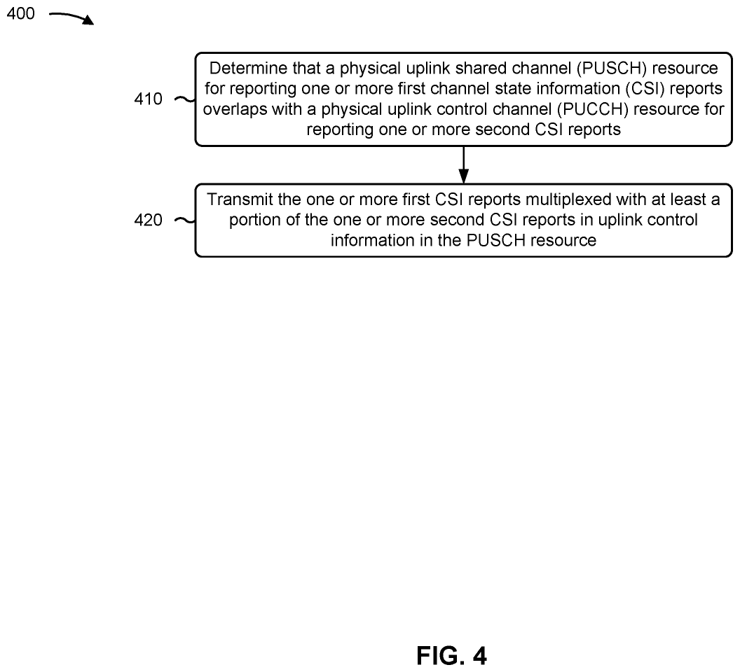

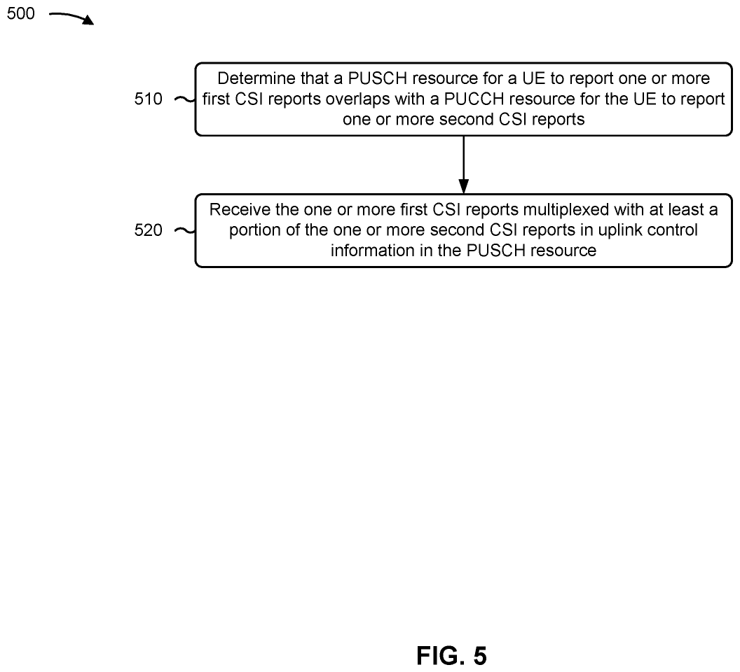

Controller/processor 240 of base station 110, controller/processor 280 of UE 120, and/or any other component(s) of FIG. 2 may perform one or more techniques associated with uplink control information multiplexing, as described in more detail elsewhere herein. For example, controller/processor 240 of base station 110, controller/processor 280 of UE 120, and/or any other component(s) of FIG. 2 may perform or direct operations of, for example, process 400 of FIG. 4, process 500 of FIG. 5, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 400 of FIG. 4, process 500 of FIG. 5, and/or other processes as described herein. In some aspects, executing instructions may include running the instructions, converting the instructions, compiling the instructions, interpreting the instructions, and/or the like.

In some aspects, UE 120 may include means for determining (e.g., using controller/processor 280, memory 282, and/or determination component 608) that a PUSCH resource for reporting one or more first CSI reports overlaps with a PUCCH resource for reporting one or more second CSI reports, means for transmitting (e.g., using transmit processor 264, TX MIMO processor 266, MOD 254, antenna 252, controller/processor 280, memory 282, and/or transmission component 604) the one or more first CSI reports multiplexed with at least a portion of the one or more second CSI reports in uplink control information in the PUSCH resource, and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining (e.g., using controller/processor 240, memory 242, and/or determination component 708) that a PUSCH resource for a UE to report one or more first CSI reports overlaps with a PUCCH resource for the UE to report one or more second CSI reports, means for receiving (e.g., using antenna 234, DEMOD 232, MIMO detector 236, receive processor 238, controller/processor 240, memory 242, scheduler 246, and/or reception component 702) the one or more first CSI reports multiplexed with at least a portion of the one or more second CSI reports in uplink control information in the PUSCH resource, and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

A base station may use channel state information (CSI) feedback to determine channel conditions for a channel between the base station and a UE. For example, the base station may transmit a CSI reference signal (CSI-RS) to one or more UEs with certain characteristics that may be available to or determinable by the UE. Using the CSI-RS, the UE may determine CSI feedback, such as a CSI report, that indicates the channel conditions between the base station and the UE.

A UE may be configured to provide CSI reporting in a physical uplink control channel (PUCCH). For example, the UE may transmit one or more periodic CSI reports multiplexed in a PUCCH. The UE may also be scheduled to provide CSI reporting in a physical uplink shared channel (PUSCH). For example, the UE may transmit one or more aperiodic CSI reports multiplexed in a PUSCH. A CSI report may be a wideband CSI report or a subband CSI report. In some aspects, the UE may multiplex one or more CSI reports with additional uplink control information (UCI), such as hybrid automatic repeat request acknowledgment (HARQ-ACK) feedback, in a PUCCH or in a PUSCH.

A CSI report may include a channel quality indicator (CQI), a precoding matrix indicator (PMI), a CSI-RS resource indicator (CRI), a layer indicator (LI), a rank indicator (RI), and/or the like. In some cases, a CSI report may include a single part. In some other cases, a CSI report may include two parts, which may be referred to herein as Part 1 CSI and Part 2 CSI. Part 1 CSI of a CSI report may have a fixed payload size, and may be used to indicate a variable payload size of Part 2 CSI of the CSI report. In some aspects (e.g., for Type 1 CSI), Part 1 CSI may include an RI, a CRI, and a CQI for a first codeword, and Part 2 CSI may include a PMI and a CQI for a second codeword (e.g., if the RI is greater than 4). In some aspects (e.g., for Type 2 CSI), Part 1 CSI may include an RI, a CQI, and an indication of a number of non-zero wideband amplitude coefficients per layer for the CSI, and Part 2 CSI may include a PMI.

Sometimes, a resource in which a UE is to transmit a CSI report may be insufficient to carry a payload size of the CSI (e.g., due to the variable payload size of Part 2 CSI). In such cases, the UE may prioritize the CSI based at least in part on one or more prioritization criteria (e.g., map the CSI according to a mapping order), and may omit one or more low priority CSI (e.g., Part 2 CSI) from the CSI report and/or omit one or more low priority CSI reports. CSI mapping orders are provided in 3GPP Technical Specification (TS) 38.212, Tables 6.3.1.1.2-7, 6.3.1.1.2-8, 6.3.1.1.2-8A, 6.3.1.1.2-9, 6.3.1.1.2-10, 6.3.1.1.2-11, 6.3.2.1.2-3, 6.3.2.1.2-4, 6.3.2.1.2-5, 6.3.2.1.2-5A, 6.3.2.1.2-6, and/or 6.3.2.1.2-7. TS 38.212, Table 6.3.2.1.2-8 indicates bitwidths used for an RI, a CQI, and an indication of a number of non-zero wideband amplitude coefficients per layer.

In some cases, a UE may be configured to provide CSI reporting in a PUCCH resource that overlaps with a PUSCH resource in which the UE is scheduled to provide CSI reporting. In such a case, the UE may drop the CSI reports that were to be transmitted in the PUCCH (e.g., even if the PUSCH has sufficient capacity to carry the CSI reports). Thus, this may result in less CSI, less relevant CSI, and/or the like, being transmitted from the UE to a base station, thereby affecting determination of channel conditions between the UE and the base station.

Some techniques and apparatuses described herein provide for multiplexing of one or more CSI reports for a PUCCH with one or more CSI reports for a PUSCH based at least in part on a determination that the PUCCH overlaps with the PUSCH. In some aspects, the CSI reports for the PUCCH may be multiplexed with the CSI reports for the PUSCH based at least in part on a determination that the PUSCH has sufficient capacity to carry one or more of the CSI reports for the PUCCH (or a portion thereof). In this way, the CSI reports for the PUCCH and the CSI reports for the PUSCH may be transmitted in a single PUSCH, rather than the CSI reports for the PUCCH being dropped. Accordingly, a robustness of the CSI reporting may be enhanced, thereby improving the determination of channel conditions at a base station.

FIG. 3 is a diagram illustrating an example 300 associated with uplink control information multiplexing, in accordance with various aspects of the present disclosure. As shown in FIG. 3, a base station 110 and a UE 120 may communicate with one another.

As shown by reference number 305, the base station 110 may transmit, and the UE 120 may receive, a configuration for CSI reporting and/or scheduling for CSI reporting. In some aspects, the UE 120 may receive a configuration (e.g., a semi-static configuration via higher-layer signaling) for periodic CSI reporting that indicates a PUCCH resource in which the UE 120 is to periodically transmit one or more CSI reports (e.g., multiplexed in the PUCCH resource). The one or more CSI reports configured in the PUCCH may be referred to as periodic CSI reports or PUCCH CSI reports. In some aspects, the UE 120 may receive scheduling (e.g., in downlink control information) for aperiodic CSI reporting that indicates a PUSCH resource in which the UE 120 is to transmit one or more CSI reports (e.g., multiplexed in the PUSCH resource). The one or more CSI reports scheduled in the PUSCH may be referred to as aperiodic CSI reports or PUSCH CSI reports.

In some aspects, the UE 120 may determine CSI (e.g., using one or more CSI-RSs) that is to be reported to the base station 110. For example, the UE 120 may determine CSI for the PUCCH CSI report(s) (which may be referred to as PUCCH CSI), and the UE 120 may determine CSI for the PUSCH CSI report(s) (which may be referred to as PUSCH CSI).

As shown by reference number 310, the UE 120 (and the base station 110) may determine that the PUCCH resource for the PUCCH CSI report(s) overlaps (e.g., in a time domain and/or a frequency domain) with the PUSCH resource for the PUSCH CSI report(s). For example, a PUCCH occasion of the periodic CSI reporting configured for the UE 120 may overlap with the PUSCH resource scheduled for aperiodic CSI reporting.

As shown by reference number 315, the UE 120 may determine to multiplex the PUCCH CSI with the PUSCH CSI in UCI that is to be transmitted in the scheduled PUSCH resource. In some aspects, the UE 120 may determine to multiplex the PUCCH CSI with the PUSCH CSI based at least in part on a determination that the PUCCH resource overlaps with the PUSCH resource. Additionally, the UE 120 may determine to multiplex the PUCCH CSI with the PUSCH CSI based at least in part on a determination that the PUSCH resource has sufficient capacity to carry at least a portion of the PUCCH CSI (e.g., at least one PUCCH CSI report, at least Part 1 CSI of a PUCCH CSI report, and/or the like). The base station 110 may also determine that the UE 120 is going to multiplex the PUCCH CSI with the PUSCH CSI, as described above (e.g., based at least in part on a determination that the PUCCH resource overlaps with the PUSCH resource).

In some cases, the PUSCH resource may be sufficient to carry the PUCCH CSI report(s) and the PUSCH CSI report(s) without omission of any CSI. In some other cases, the PUSCH resource may be insufficient to carry the PUCCH CSI report(s) and the PUSCH CSI report(s), and the UE 120 may perform an omission procedure to reduce a payload size of the PUCCH CSI report(s) and the PUSCH CSI report(s).

For example, the UE 120 may map the PUCCH CSI and the PUSCH CSI to the UCI (e.g., to the PUSCH resource) in a mapping order. In other words, the UE 120 may prioritize the PUCCH CSI and/or the PUSCH CSI according to one or more prioritization criteria (e.g., the mapping order), and may omit one or more low priority CSI from the UCI. In some aspects, the UE 120 may determine to omit CSI (e.g., according to the prioritization criteria) from the UCI based at least in part on a payload size of the UCI (e.g., a size of the PUSCH resource). For example, the UE 120 may determine to omit CSI, beginning from the lowest priority CSI, until the size of the PUCCH CSI and PUSCH CSI fits in the payload size of the UCI.

In some aspects, the omission may be CSI report-based, where a lower-priority CSI report, or parts thereof, is omitted before a higher-priority CSI report, or parts thereof, is omitted (which may be similar to a prioritization used for omission of CSI reports transmitted in a PUCCH). In some aspects, the prioritization criteria may indicate that the PUCCH CSI is to be omitted before the PUSCH CSI (e.g., PUSCH CSI is mapped before PUCCH CSI), a lower-priority CSI report is to be omitted before a higher-priority CSI report (e.g., a higher priority CSI report is mapped before a lower-priority CSI report), and/or Part 2 CSI of a CSI report is to be omitted before Part 1 CSI of the same CSI report (e.g., Part 1 CSI for a CSI report is mapped before Part 2 CSI of the CSI report). In particular, the omission may have the following order (in order from first to be omitted to last to be omitted): (1) Part 2 CSI of a lower-priority CSI report (e.g., a subband CSI report); (2) Part 1 CSI of the lower-priority CSI report, or a lower-priority wideband CSI report; (3) Part 2 CSI of a higher-priority CSI report (e.g., a subband CSI report); and (4) Part 1 CSI of a higher-priority CSI report, or a higher-priority wideband CSI report. In some aspects, the omission may begin with the PUCCH CSI report(s), and the PUSCH CSI report(s), or parts thereof, may be omitted only if all PUCCH CSI report(s) have been omitted.

In some aspects, the omission may be CSI part-based, where Part 2 CSI is omitted (for a lower-priority CSI report first) before Part 1 CSI is omitted (which may be similar to a prioritization used for omission of CSI reports transmitted in a PUSCH). In some aspects, the prioritization criteria may indicate that the PUCCH CSI is to be omitted before the PUSCH CSI (e.g., PUSCH CSI is mapped before PUCCH CSI), Part 2 CSI of the PUCCH CSI report(s) is to be omitted before Part 1 CSI of the PUCCH CSI report(s) (e.g., Part 1 CSI of the PUCCH CSI report(s) is mapped before Part 2 CSI of the PUCCH CSI report(s)), and/or Part 2 CSI of the PUSCH CSI report(s) is to be omitted before Part 1 CSI of the PUSCH CSI report(s) (e.g., Part 1 CSI of the PUSCH CSI report(s) is mapped before Part 2 CSI of the PUSCH CSI report(s)). In particular, the omission may have the following order (in order from first to be omitted to last to be omitted): (1) Part 2 CSI of the PUCCH CSI report(s) (which may be referred to as group 1 CSI reports); (2) Part 1 CSI of the PUCCH CSI report(s) (group 1); and (3) Part 2 CSI of the PUSCH CSI report(s) (which may be referred to as group 2). Thus, the omission may begin with group 1, and CSI for group 2 is omitted only if all group 1 CSI reports have been omitted.

In some aspects, the UE 120 may determine a quantity of CSI reports (N) that are to be included (e.g., multiplexed) in the UCI. In some aspects, the quantity of CSI reports may be a total quantity of the PUCCH CSI report(s) and the PUSCH CSI report(s) (e.g., if the PUSCH resource is sufficient to carry the PUCCH CSI report(s) and the PUSCH CSI report(s) without omission of any CSI). In some aspects, the quantity of CSI reports may be less than a total quantity of the PUCCH CSI report(s) and the PUSCH CSI report(s) (e.g., if the PUSCH resource is insufficient to carry the PUCCH CSI report(s) and the PUSCH CSI report(s), and one or more CSI reports are omitted, as described above). The UCI may include (e.g., in a first part of the UCI) an indication of the quantity of CSI reports that are included in the UCI, as described below. In some aspects, the quantity of CSI reports may be only a quantity of the PUCCH CSI report(s) (and not include a quantity of the PUSCH CSI report(s)), and a PUCCH CSI report is not counted toward the quantity of CSI reports if all of the PUCCH CSI report is omitted, as described above.

As shown by reference number 320, the UE 120 may transmit, and the base station 110 may receive, the PUSCH CSI, or a portion thereof, multiplexed with the PUCCH CSI, or a portion thereof, in the UCI in the PUSCH resource. That is, the UE 120 may transmit the PUSCH CSI report(s), or a portion thereof, multiplexed with the PUCCH CSI report(s), or a portion thereof, in the PUSCH resource.

For example, FIG. 3 shows two examples of PUCCH CSI report(s) and PUSCH CSI report(s) multiplexed in UCI. In the example on the left side of FIG. 3, the UCI may include two CSI reports, and therefore the UCI may include an indication that a quantity of CSI reports (N) included in the UCI is two. In the example on the right side of FIG. 3, the UCI may include three CSI reports, and therefore the UCI may include an indication that a quantity of CSI reports (N) included in the UCI is three.

In some aspects, the UE 120 may report the UCI in a first part and a second part. The first part may indicate (e.g., in the following order) Part 1 CSI for each of the PUSCH CSI report(s), the quantity of CSI reports that are included in the UCI, and/or a respective quantity of transport blocks associated with each of the one or more PUCCH CSI report(s) (e.g., an RI or another indication of the quantity of transport blocks). The second part may indicate (e.g., in the following order) Part 2 CSI of the PUSCH CSI report(s), after omission, and/or the PUCCH CSI report(s) (e.g., Part 1 CSI and/or Part 2 CSI of the PUCCH CSI report(s)) after omission. In some aspects, the omission procedure used for the Part 2 CSI of the PUSCH CSI report(s) and/or the PUCCH CSI report(s) may be the CSI report-based omission procedure described above, the CSI part-based omission procedure described above, and/or another omission procedure.

In some aspects, the UE 120 may report the UCI in a first part, a second part, and a third part. The first part may indicate (e.g., in the following order) Part 1 CSI for each of the PUSCH CSI report(s) and/or the quantity of CSI reports that are included in the UCI. The second part may indicate (e.g., in the following order) a respective quantity of transport blocks associated with each of the one or more PUCCH CSI report(s) (e.g., an RI or another indication of the quantity of transport blocks) and/or Part 2 CSI of the PUSCH CSI report(s) after omission. The third part may indicate the PUCCH CSI report(s) (e.g., Part 1 CSI and/or Part 2 CSI of the PUCCH CSI report(s)) after omission. In some aspects, the omission procedure used for the Part 2 CSI of the PUSCH CSI report(s) and/or the PUCCH CSI report(s) may be the CSI report-based omission procedure described above, the CSI part-based omission procedure described above, and/or another omission procedure.

In some aspects, the base station 110 may determine a content of the UCI based at least in part on the quantity of CSI reports indicated in the UCI. For example, the base station 110 may determine a content of the first part of the UCI based at least in part on the quantity of CSI reports indicated in the UCI, and the base station 110 may use the content of the first part to determine a content of the second part and/or the third part of the UCI. In this way, the PUCCH CSI report(s) and the PUSCH CSI report(s) may be multiplexed in the PUSCH resource, thereby improving a robustness of CSI reporting of the UE 120.

As indicated above, FIG. 3 is provided as an example. Other examples may differ from what is described with respect to FIG. 3.

FIG. 4 is a diagram illustrating an example process 400 performed, for example, by a UE, in accordance with various aspects of the present disclosure. Example process 400 is an example where the UE (e.g., UE 120) performs operations associated with uplink control information multiplexing.

As shown in FIG. 4, in some aspects, process 400 may include determining that a PUSCH resource for reporting one or more first CSI reports overlaps with a PUCCH resource for reporting one or more second CSI reports (block 410). For example, the UE (e.g., using controller/processor 280, memory 282, and/or determination component 608) may determine that a PUSCH resource for reporting one or more first CSI reports overlaps with a PUCCH resource for reporting one or more second CSI reports, as described above.

As further shown in FIG. 4, in some aspects, process 400 may include transmitting the one or more first CSI reports multiplexed with at least a portion of the one or more second CSI reports in uplink control information in the PUSCH resource (block 420). For example, the UE (e.g., using transmit processor 264, TX MIMO processor 266, MOD 254, antenna 252, controller/processor 280, memory 282, and/or transmission component 604) may transmit the one or more first CSI reports multiplexed with at least a portion of the one or more second CSI reports in uplink control information in the PUSCH resource, as described above.

Process 400 may include additional aspects, such as any single aspect or any combination of aspects described below and/or in connection with one or more other processes described elsewhere herein.

In a first aspect, the one or more first CSI reports include one or more aperiodic CSI reports, and the one or more second CSI reports include one or more periodic CSI reports.

In a second aspect, alone or in combination with the first aspect, the uplink control information indicates a quantity of CSI reports that are included in the uplink control information.

In a third aspect, alone or in combination with one or more of the first and second aspects, process 400 includes determining (e.g., using controller/processor 280, memory 282, and/or determination component 608) CSI, of at least one of the one or more first CSI reports or the one or more second CSI reports, that is to be omitted from the uplink control information based at least in part on a size of the PUSCH resource.

In a fourth aspect, alone or in combination with one or more of the first through third aspects, the one or more second CSI reports are to be omitted before the one or more first CSI reports, a lower-priority CSI report is to be omitted before a higher-priority CSI report, and Part 2 CSI of a CSI report is to be omitted before Part 1 CSI of the CSI report.

In a fifth aspect, alone or in combination with one or more of the first through fourth aspects, the one or more second CSI reports are to be omitted before the one or more first CSI reports, Part 2 CSI of the one or more second CSI reports is to be omitted before Part 1 CSI of the one or more second CSI reports, and Part 2 CSI of the one or more first CSI reports is to be omitted before Part 1 CSI of the one or more first CSI reports.

In a sixth aspect, alone or in combination with one or more of the first through fifth aspects, the uplink control information includes a first part and a second part.

In a seventh aspect, alone or in combination with one or more of the first through sixth aspects, the first part indicates one or more of: Part 1 CSI for the one or more first CSI reports, a quantity of CSI reports that are included in the uplink control information, or a quantity of transport blocks respectively associated with the one or more second CSI reports.

In an eighth aspect, alone or in combination with one or more of the first through seventh aspects, the second part indicates one or more of: Part 2 CSI that is not omitted for the one or more first CSI reports, or at least one of Part 1 CSI or Part 2 CSI that is not omitted for the one or more second CSI reports.

In a ninth aspect, alone or in combination with one or more of the first through eighth aspects, the uplink control information includes a first part, a second part, and a third part.

In a tenth aspect, alone or in combination with one or more of the first through ninth aspects, the first part indicates one or more of: Part 1 CSI for the one or more first CSI reports, or a quantity of CSI reports that are included in the uplink control information.

In an eleventh aspect, alone or in combination with one or more of the first through tenth aspects, the second part indicates one or more of: Part 2 CSI that is not omitted for the one or more first CSI reports, or a quantity of transport blocks respectively associated with the one or more second CSI reports.

In a twelfth aspect, alone or in combination with one or more of the first through eleventh aspects, the third part indicates at least one of Part 1 CSI or Part 2 CSI that is not omitted for the one or more second CSI reports.

Although FIG. 4 shows example blocks of process 400, in some aspects, process 400 may include additional blocks, fewer blocks, different blocks, or differently arranged blocks than those depicted in FIG. 4. Additionally, or alternatively, two or more of the blocks of process 400 may be performed in parallel.

FIG. 5 is a diagram illustrating an example process 500 performed, for example, by a base station, in accordance with various aspects of the present disclosure. Example process 500 is an example where the base station (e.g., base station 110) performs operations associated with uplink control information multiplexing.

As shown in FIG. 5, in some aspects, process 500 may include determining that a PUSCH resource for a UE to report one or more first CSI reports overlaps with a PUCCH resource for the UE to report one or more second CSI reports (block 510). For example, the base station (e.g., using controller/processor 240, memory 242, and/or determination component 708) may determine that a PUSCH resource for a UE to report one or more first CSI reports overlaps with a PUCCH resource for the UE to report one or more second CSI reports, as described above.

As further shown in FIG. 5, in some aspects, process 500 may include receiving the one or more first CSI reports multiplexed with at least a portion of the one or more second CSI reports in uplink control information in the PUSCH resource (block 520). For example, the base station (e.g., using antenna 234, DEMOD 232, MIMO detector 236, receive processor 238, controller/processor 240, memory 242, scheduler 246, and/or reception component 702) may receive the one or more first CSI reports multiplexed with at least a portion of the one or more second CSI reports in uplink control information in the PUSCH resource, as described above.

Process 500 may include additional aspects, such as any single aspect or any combination of aspects described below and/or in connection with one or more other processes described elsewhere herein.

In a first aspect, the one or more first CSI reports include one or more aperiodic CSI reports, and the one or more second CSI reports include one or more periodic CSI reports.

In a second aspect, alone or in combination with the first aspect, the uplink control information indicates a quantity of CSI reports that are included in the uplink control information.

In a third aspect, alone or in combination with one or more of the first and second aspects, process 500 includes determining (e.g., using controller/processor 240, memory 242, and/or determination component 708) CSI, of at least one of the one or more first CSI reports or the one or more second CSI reports, that is included in the uplink control information based at least in part on the quantity of CSI reports.

In a fourth aspect, alone or in combination with one or more of the first through third aspects, the one or more second CSI reports are to be omitted before the one or more first CSI reports, a lower-priority CSI report is to be omitted before a higher-priority CSI report, and Part 2 CSI of a CSI report is to be omitted before Part 1 CSI of the CSI report.

In a fifth aspect, alone or in combination with one or more of the first through fourth aspects, the one or more second CSI reports are to be omitted before the one or more first CSI reports, Part 2 CSI of the one or more second CSI reports is to be omitted before Part 1 CSI of the one or more second CSI reports, and Part 2 CSI of the one or more first CSI reports is to be omitted before Part 1 CSI of the one or more first CSI reports.

In a sixth aspect, alone or in combination with one or more of the first through fifth aspects, the uplink control information includes a first part and a second part.

In a seventh aspect, alone or in combination with one or more of the first through sixth aspects, the first part indicates one or more of: Part 1 CSI for the one or more first CSI reports, a quantity of CSI reports that are included in the uplink control information, or a quantity of transport blocks respectively associated with the one or more second CSI reports.

In an eighth aspect, alone or in combination with one or more of the first through seventh aspects, the second part indicates one or more of: Part 2 CSI that is not omitted for the one or more first CSI reports, or at least one of Part 1 CSI or Part 2 CSI that is not omitted for the one or more second CSI reports.

In a ninth aspect, alone or in combination with one or more of the first through eighth aspects, the uplink control information includes a first part, a second part, and a third part.

In a tenth aspect, alone or in combination with one or more of the first through ninth aspects, the first part indicates one or more of: Part 1 CSI for the one or more first CSI reports, or a quantity of CSI reports that are included in the uplink control information.

In an eleventh aspect, alone or in combination with one or more of the first through tenth aspects, the second part indicates one or more of: Part 2 CSI that is not omitted for the one or more first CSI reports, or a quantity of transport blocks respectively associated with the one or more second CSI reports.

In a twelfth aspect, alone or in combination with one or more of the first through eleventh aspects, the third part indicates at least one of Part 1 CSI or Part 2 CSI that is not omitted for the one or more second CSI reports.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

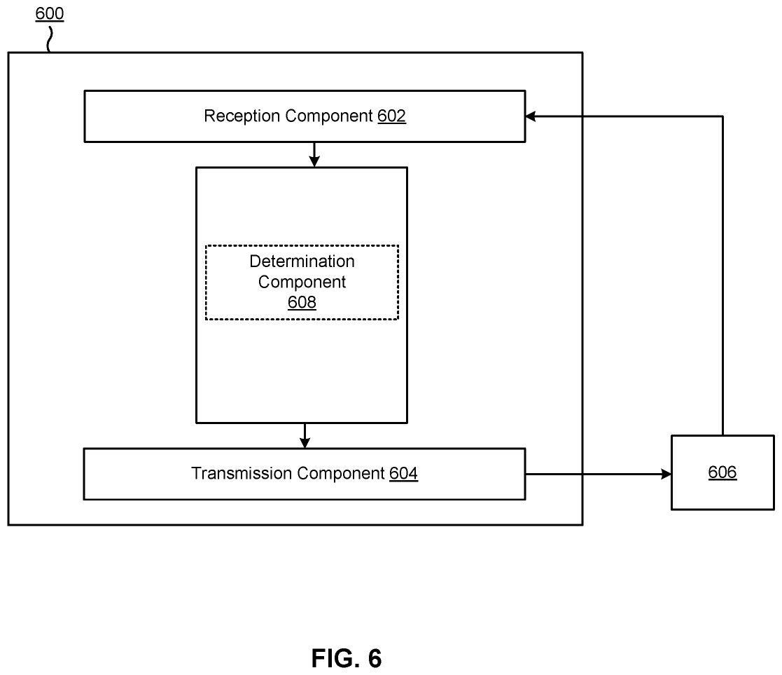

FIG. 6 is a diagram of an example apparatus 600 for wireless communication, in accordance with various aspects of the present disclosure. The apparatus 600 may be a UE, or a UE may include the apparatus 600. In some aspects, the apparatus 600 includes a reception component 602 and a transmission component 604, which may be in communication with one another (for example, via one or more buses and/or one or more other components). As shown, the apparatus 600 may communicate with another apparatus 606 (such as a UE, a base station, or another wireless communication device) using the reception component 602 and the transmission component 604. As further shown, the apparatus 600 may include a determination component 608, among other examples.

In some aspects, the apparatus 600 may be configured to perform one or more operations described herein in connection with FIG. 3. Additionally or alternatively, the apparatus 600 may be configured to perform one or more processes described herein, such as process 400 of FIG. 4, or a combination thereof. In some aspects, the apparatus 600 and/or one or more components shown in FIG. 6 may include one or more components of the UE described above in connection with FIG. 2. Additionally, or alternatively, one or more components shown in FIG. 6 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications (such as filtering, amplification, demodulation, analog-to-digital conversion, demultiplexing, other examples), and may provide the processed signals to the one or more other components of the apparatus 606. In some aspects, the reception component 602 may include one or more antennas, a demodulator, a MIMO detector, a receive processor, a controller/processor, a memory, or a combination thereof, of the UE described above in connection with FIG. 2.

The transmission component 604 may transmit communications, such as reference signals, control information, data communications, or a combination thereof, to the apparatus 606. In some aspects, one or more other components of the apparatus 606 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more antennas, a modulator, a transmit MIMO processor, a transmit processor, a controller/processor, a memory, or a combination thereof, of the UE described above in connection with FIG. 2. In some aspects, the transmission component 604 may be collocated with the reception component 602 in a transceiver.

The determination component 608 may determine that a PUSCH resource for reporting one or more first CSI reports overlaps with a PUCCH resource for reporting one or more second CSI reports. In some aspects, the determination component 608 may include a controller/processor, a memory, or a combination thereof, of the UE described above in connection with FIG. 2. The transmission component 604 may transmit the one or more first CSI reports multiplexed with at least a portion of the one or more second CSI reports in uplink control information in the PUSCH resource. In some aspects, the determination component 608 may determine CSI, of at least one of the one or more first CSI reports or the one or more second CSI reports, that is to be omitted from the uplink control information based at least in part on a size of the PUSCH resource.

The quantity and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

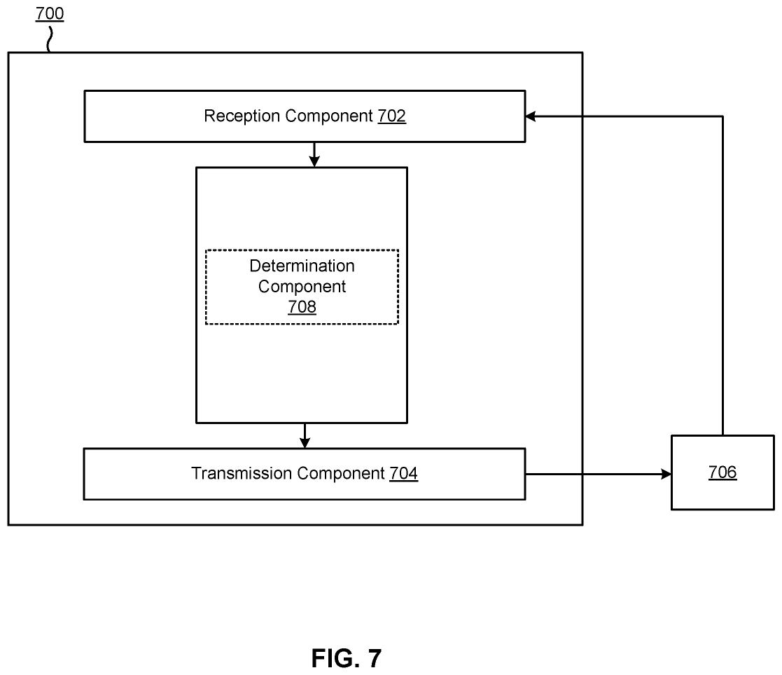

FIG. 7 is a diagram of an example apparatus 700 for wireless communication, in accordance with various aspects of the present disclosure. The apparatus 700 may be a base station, or a base station may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a determination component 708, among other examples.

In some aspects, the apparatus 700 may be configured to perform one or more operations described herein in connection with FIG. 3. Additionally or alternatively, the apparatus 700 may be configured to perform one or more processes described herein, such as process 500 of FIG. 5, or a combination thereof. In some aspects, the apparatus 700 and/or one or more components shown in FIG. 7 may include one or more components of the base station described above in connection with FIG. 2. Additionally, or alternatively, one or more components shown in FIG. 7 may be implemented within one or more components described above in connection with FIG. 2. Additionally or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the base station described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the base station described above in connection with FIG. 2. In some aspects, the transmission component 704 may be collocated with the reception component 702 in a transceiver.

The determination component 708 may determine that a PUSCH resource for a UE to report one or more first CSI reports overlaps with a PUCCH resource for the UE to report one or more second CSI reports. In some aspects, the determination component 708 may include a controller/processor, a memory, or a combination thereof, of the base station described above in connection with FIG. 2. The reception component 702 may receive the one or more first CSI reports multiplexed with at least a portion of the one or more second CSI reports in uplink control information in the PUSCH resource. In some aspects, the determination component 708 may determine CSI, of at least one of the one or more first CSI reports or the one or more second CSI reports, that is included in the uplink control information based at least in part on the quantity of CSI reports.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
determining that a physical uplink shared channel (PUSCH) resource for reporting one or more first channel state information (CSI) reports overlaps with a physical uplink control channel (PUCCH) resource for reporting one or more second CSI reports; and
transmitting the one or more first CSI reports multiplexed with at least a portion of the one or more second CSI reports in uplink control information in the PUSCH resource.

2. The method of claim 1, wherein the one or more first CSI reports comprise one or more aperiodic CSI reports, and the one or more second CSI reports comprise one or more periodic CSI reports.

3. The method of claim 1, wherein the uplink control information indicates a quantity of CSI reports that are included in the uplink control information.

4. The method of claim 1, further comprising:
determining CSI, of at least one of the one or more first CSI reports or the one or more second CSI reports, that is to be omitted from the uplink control information based at least in part on a size of the PUSCH resource.

5. The method of claim 4, wherein the one or more second CSI reports are to be omitted before the one or more first CSI reports,
wherein a lower-priority CSI report is to be omitted before a higher-priority CSI report, and
wherein Part 2 CSI of a CSI report is to be omitted before Part 1 CSI of the CSI report.

6. The method of claim 4, wherein the one or more second CSI reports are to be omitted before the one or more first CSI reports,
wherein Part 2 CSI of the one or more second CSI reports is to be omitted before Part 1 CSI of the one or more second CSI reports, and
wherein Part 2 CSI of the one or more first CSI reports is to be omitted before Part 1 CSI of the one or more first CSI reports.

7. The method of claim 1, wherein the uplink control information includes a first part and a second part.

8. The method of claim 7, wherein the first part indicates one or more of:
Part 1 CSI for the one or more first CSI reports,
a quantity of CSI reports that are included in the uplink control information, or
a quantity of transport blocks respectively associated with the one or more second CSI reports.

9. The method of claim 7, wherein the second part indicates one or more of:
Part 2 CSI that is not omitted for the one or more first CSI reports, or
at least one of Part 1 CSI or Part 2 CSI that is not omitted for the one or more second CSI reports.

10. The method of claim 1, wherein the uplink control information includes a first part, a second part, and a third part.

11. The method of claim 10, wherein the first part indicates one or more of:
Part 1 CSI for the one or more first CSI reports, or
a quantity of CSI reports that are included in the uplink control information.

12. The method of claim 10, wherein the second part indicates one or more of:
Part 2 CSI that is not omitted for the one or more first CSI reports, or
a quantity of transport blocks respectively associated with the one or more second CSI reports.

13. The method of claim 10, wherein the third part indicates at least one of Part 1 CSI or Part 2 CSI that is not omitted for the one or more second CSI reports.

14. A method of wireless communication performed by a base station, comprising:
determining that a physical uplink shared channel (PUSCH) resource for a user equipment (UE) to report one or more first channel state information (CSI) reports overlaps with a physical uplink control channel (PUCCH) resource for the UE to report one or more second CSI reports; and
receiving the one or more first CSI reports multiplexed with at least a portion of the one or more second CSI reports in uplink control information in the PUSCH resource.

15. The method of claim 14, wherein the one or more first CSI reports comprise one or more aperiodic CSI reports, and the one or more second CSI reports comprise one or more periodic CSI reports.

16. The method of claim 14, wherein the uplink control information indicates a quantity of CSI reports that are included in the uplink control information.

17. The method of claim 14, further comprising:
determining CSI, of at least one of the one or more first CSI reports or the one or more second CSI reports, that is included in the uplink control information based at least in part on a quantity of CSI reports.

18. The method of claim 17, wherein the one or more second CSI reports are to be omitted before the one or more first CSI reports,
wherein a lower-priority CSI report is to be omitted before a higher-priority CSI report, and
wherein Part 2 CSI of a CSI report is to be omitted before Part 1 CSI of the CSI report.

19. The method of claim 17, wherein the one or more second CSI reports are to be omitted before the one or more first CSI reports,
wherein Part 2 CSI of the one or more second CSI reports is to be omitted before Part 1 CSI of the one or more second CSI reports, and
wherein Part 2 CSI of the one or more first CSI reports is to be omitted before Part 1 CSI of the one or more first CSI reports.

20. The method of claim 14, wherein the uplink control information includes a first part and a second part.

21. The method of claim 20, wherein the first part indicates one or more of:
Part 1 CSI for the one or more first CSI reports,
a quantity of CSI reports that are included in the uplink control information, or
a quantity of transport blocks respectively associated with the one or more second CSI reports.

22. The method of claim 20, wherein the second part indicates one or more of:
Part 2 CSI that is not omitted for the one or more first CSI reports, or
at least one of Part 1 CSI or Part 2 CSI that is not omitted for the one or more second CSI reports.

23. The method of claim 14, wherein the uplink control information includes a first part, a second part, and a third part.

24. The method of claim 23, wherein the first part indicates one or more of:
Part 1 CSI for the one or more first CSI reports, or
a quantity of CSI reports that are included in the uplink control information.

25. The method of claim 23, wherein the second part indicates one or more of:
Part 2 CSI that is not omitted for the one or more first CSI reports, or
a quantity of transport blocks respectively associated with the one or more second CSI reports.

26. The method of claim 23, wherein the third part indicates at least one of Part 1 CSI or Part 2 CSI that is not omitted for the one or more second CSI reports.

27. A user equipment (UE) for wireless communication, comprising:
a memory; and
one or more processors operatively coupled to the memory, the memory and the one or more processors configured to:
determine that a physical uplink shared channel (PUSCH) resource for reporting one or more first channel state information (CSI) reports overlaps with a physical uplink control channel (PUCCH) resource for reporting one or more second CSI reports; and
transmit the one or more first CSI reports multiplexed with at least a portion of the one or more second CSI reports in uplink control information in the PUSCH resource.

28. A base station for wireless communication, comprising:
a memory; and
one or more processors operatively coupled to the memory, the memory and the one or more processors configured to:
determine that a physical uplink shared channel (PUSCH) resource for a user equipment (UE) to report one or more first channel state information (CSI) reports overlaps with a physical uplink control channel (PUCCH) resource for the UE to report one or more second CSI reports; and
receive the one or more first CSI reports multiplexed with at least a portion of the one or more second CSI reports in uplink control information in the PUSCH resource.

29-32. (canceled)

33. The UE of claim 27, wherein the one or more first CSI reports comprise one or more aperiodic CSI reports, and the one or more second CSI reports comprise one or more periodic CSI reports.

34. The UE of claim 27, wherein the uplink control information indicates a quantity of CSI reports that are included in the uplink control information.
